(19) United States
(12) Patent Application Publication
(10) Pub. No.: US 2005/0022264 A1
(43) Pub. Date: Jan. 27, 2005

(54) Method and a device for determination of the actual photosynthesis in plants

(76) Inventor: Anne Marie Fanger, Lensahn (DE)

Correspondence Address: Cooper & Dunham, 1185 Avenue of the Americas, New York, NY, 10036, US

(21) Appl. No.: 10/494,900

(22) PCT Filed: Nov. 7, 2002
(86) PCT No.: PCT/DK02/00747

(30) Foreign Application Priority Data
Nov. 8, 2001 (DK) PA 2001 01654

(51) Int. Cl. H01J 40/14; H01J 3/14; H01J 5/16

(52) U.S. Cl. 800/282; 250/216

(57) ABSTRACT

The invention relates to a novel method for simple and direct determination of the actual photosynthesis (the gross photosynthesis), the light respiration and the uptake and emission of CO2, O2 and H2O in connection with photosynthesis and respiration in plants. The invention also relates to a device for carrying out the method and use of the method for evaluation of the growth of algae and plants. The method of the invention is based on the new recognition that photosynthesis is not a chemical process but rather a one step physical reaction. The method is very different from the methods applied so far and much more accurate than these known methods. It has a great potential utility in agriculture and forestry. The method can be worked from great heights using aeroplanes or satellites. It can be used in all types of apparatuses, computers and computer programs designed for estimation of plant productivity and photosynthesis.

### BACKGROUND OF THE INVENTION

The present invention relates to a method for the determination of the actual photosynthesis (the gross photosynthesis), the light respiration and the uptake and emission of CO₂, O₂ and H₂O in connection with photosynthesis and respiration in plants. The invention also relates to a device for carrying out the method and use of the method for evaluation of the growth of algae and plants.

More specifically the invention relates to a method for determination of the actual photosynthesis (the gross photosynthesis) of plants, wherein:
the light photon flux falling on the photosynthetising surface area of the leaves is measured and converted directly to the amount of glucose produced per unit of the photosynthetising area of the plant or the plant area per unit of time by means of the conversion factor 1/36, as it requires 36 photons to produce one molecule of glucose, and the absorption of the light photon flux is related to the surface area of the plant. The actual photosynthesis reaches a maximum at the optimal light photon flux 1/6 μmole cm⁻² s⁻¹ for plants which do not have an accessory carbon dioxide concentration mechanism (C₄ and CAM plants), for the latter the actual photosynthesis continues to follow the function 1/36 ×photon flux above the optimal photon flux, ⅙ μmole cm⁻² s⁻¹,
the total actual photosynthesis of the plant, the plant part or the plant area is calculated by multiplying the actual photosynthesis by the size of the area, and optionally
the light respiration of plants is determined by multiplying the actual photosynthesis by the conversion factor 5/6, as 5/6 of the amount of CO₂ necessary for the actual photosynthesis is produced by the light respiration.

The method according to the invention involves a simple and direct measurement of the light photon flux falling on the photosynthesising area of the plant. The photon flux is converted to the produced amount of glucose/H₂O, CO₂, O₂ per unit of area per unit of time, and if a determination of the actual photosynthesis (the gross photosynthesis), the net photosynthesis, the light respiration and the CO₂, O₂ and H₂O consumption/production for a plant unit, a whole plant or a plant area is desired, the rate per unit of area per unit of time found is multiplied by the area belonging to the given photon flux.

The method of the invention is in principle very simple. But as the conversion factor between light and glucose production has never been determined with accuracy, it has not until now been possible to determine the actual photosynthetic rate (plant gross production).

The net photosynthesis that previously has been determined as the external carbon dioxide uptake can now be determined by conversion of the photon flux. The invention is based upon the fact that a determination of the internal carbon dioxide production called light respiration or photorespiration in plants has now become possible. All the processes of plants connected to photosynthesis, the actual photosynthesis, the net photosynthesis, the light respiration and the carbon dioxide, oxygen and water uptake and production connected to these processes can now be determined by simple measurement of the light photon flux and the photosynthesising area of plants.

The method according to the invention and the use thereof is based on a novel approach to the concept of photosynthesis. This approach is very different from the theories and models, which have been thought valid for the last century. The invention rests on the new recognition that photosynthesis is not a multi-step chemical reaction, but rather a physical one-step process:

According to the new concept, the light photons are absorbed directly by a hexagonal constellation of carbon dioxide and water molecules, which functions like a small electro motor. Each light photon exitates one of the 36 electrons of the 6 carbon atoms into circulation in the hexagon and thus binding the carbon dioxide molecules together with the water molecules to the glucose hexagon. When 36 light photons have passed through the hexagon the glucose molecule has been formed. A physical process (Fanger, A. M.: Dr. sci. (Dr. dr.) thesis, not yet submitted).

According to the previous theories, the light photons have been thought to be absorbed by chlorophyll and bound as electropotential energy, which via an electron transport chain was believed to lead to the chemical circular process called the Calvin cycle. In the Calvin cycle carbon dioxide and water molecules have been considered as being built together via several chemical reactions to form the glucose molecule (Litterature: Gibbs, M.: “Structure and Function of Chloroplasts”, Springer Verlag, New York (1971); Hill, R. and Bendall, F: Function of the two cytochrome components in chloroplasts: a working hypo-thesis. Nature 186: 136-137 (1960); Calvin, M. and Bassham, J. A: “The photosynthesis of Carbon Compounds”. W. A. Benjamin, Inc., New York.(1962); Bassham, J. A., and Calvin, M.: The Path of Carbon in Photosynthesis. Prentice-Hall Inc., Englewood. (1957)).

Prior Art

The photosynthetic process can be described by the equation:
6CO₂+12H₂O+light photons-->C₆H₁₂O₆+6O₂+6H₂O

Each of the factors in the photosynthetic equation can be used—and has been used—for the determination of the photosynthetic rate (moles of glucose produced per unit of area or per unit of water flux volume (or weight) per unit of time). The problem has always been to separate the photosynthetic activity from the respiration (the glycolysis), as the respiration can be seen as the opposite reaction of the photosynthesis:
C₆H₁₂O₆+6O₂+6H₂O------>6 CO₂+12H₂O+energy

The only component, which separates the two processes, is the factor light. But until now there has been controversy among experts as to how many light photons are necessary for the formation of one mole of glucose (Hopkins, W. G., Introduction to Plant Physiology, John Wiley & Sons (1999)). Furthermore it has not been known whether the plant possibly functions like a prism and thus is able to upconcentrate light (Bjørn, L. O. and Vogelmann, T. C.: Quantifying Light and UltravioletRadiation in Plant Biology, Photochemistry and Photobiology 64(3), 403-406 (1995)). It has until now not been possible to determine plant photosynthesis by light measurements. In one of the latest reviews on the subject of carbohydrate production (photosynthesis) John Farrar remarks: “A complete theory of photosynthetic regulation will therefore integrate the partitioning that underlies leaf area per plant with the mechanisms which control density of photosynthetic machinery per unit of area of leaf. We do not have such a theory currently” (Farrar, J: Carbohydrate: Where does it come from, where does it go? In: Plant carbohydrate biochemestry, ed. Bryant, John Allen, Oxford Bios Scientific Publ. Environmental plant Biological series: p: 29-46 (1999). The previously applied methods have thus either measured the uptake of carbon dioxide, the emission of oxygen or the carbohydrate accumulation (harvest methods) as a measure for photosynthetic activity and/or growth (review see: Wittaker, R. H. Communities and Ecosystems, Mac Millan Publishing, New York (1975); Søndergaard, M. and Riemann, B., Ferskvandsbiologiske Analysemetoder, Akademisk Forlag (1979); Nielsson, H. E., Remote sensing and image Analysis in Plant Pathology, Ann. Rev. of Plant Phytopathology 15, 489-527 (1995) and Buschmann, C. and Lichtenthaler, H. K., Principles and Characteristics of Multicol or Fluorescence Imaging of Plants, J. of Plant Physiol. 112, 297-314 (1998)). The methods can be classified as follows:

1) Carbohydrate Accumulation (Determination of Length, Thickness and Weight):

The methods used here involve harvesting and drying of plant material, which is then converted to carbohydrate accumulated per unit of time. Thickness and height measurements are traditionally used in forestring (Wittaker, R. H., supra), but also in connection with weeds (Rosema, J. et al., Journal of Experimental vol. 38, nr. 188: 442-453 (1987)) and with roots (Hackett, C., New Phythol. 68, 1023-1030 (1969)).

2) Carbon Dioxide:

a) The net exchange of carbon dioxide with the external air, measured with Infra Red Gas Analyser, where a determination of the carbon dioxide difference between the ingoing and outgoing air of a plant measurement chamber gives a measurement of the net photosynthetic rate (Parkinson, K. J. and Legg, B. J., J. Phys. E. Sci. Instrum. 4, 598-600 (1971)). As this method of measurement does not separate photosynthesis and respiration, the expression net photosynthesis is used. The method has been much used for the last 25 years and is still much used. The method is used in scientific experiments but is also of economic importance in the evaluation of crop plant production in agriculture as well as forestry (see also: Long, S. P. and Woolhouse, H. W., J. Exp. Bot. 29: 567-577 (1978); Fanger, A. M., The Influence of Nitrate and Sodium Chloride on Growth, Photosynthesis, Root respiration and release of Root Exudate of Spartina Anglica (C. E. Hubbard) elucidated by experiments in the Laboratory, The University of Aarhus, Denmark (1982)).
b) Incorporation of the radioactive tracer C¹⁴, taken up as C¹⁴O₂ or C¹⁴O₃, can be used for estimation of carbon dioxide in plants (Fanger, A. M. (1982), supra) and is the standard employed method for estimation of productivity of phytoplankton (Søndergaard, M. and Riemann, B., (1979) supra).
   3) Oxygen:

The productivity of higher plants as well as of phytoplankton can be measured by determination of oxygen either by titration or by means of oxygen electrodes. The titration method has not been used as much as the measurement of carbon dioxide as it is not as accurate (Søndergaard, M. and Riemann, B., supra).

4) Photosynthetic Enzymes:

A lot of experiments have been undertaken to examine whether photosynthetic enzymes can be used as a parameter for the photosynthetic rate (Cambell et al. (1988), Plant Phy-siol. 88, 1310-1316; Bowes, G. (1991), Plant cell and Environment 14, 795-806. Stitt, M. and Schulze, D. (1994), Plant Cell and Environment 17: 465-487. Harmens, H. et al. (2000), Physiologia Plantarum 108: 43-50).

5) Light:

A crude determination of plant covered areas can be undertaken from aeroplanes or satellites (Nilsson, H. E., supra). Fluorescence methods have also been developed recently, but so far they can only be used as a measurement of diseases and as a measurement of chlorophyll (potential photosynthetic capacity) (Buschmann and Lichtenthaler (1998) supra). However, as mentionedpreviously it has not been known whether plants are able to concentrate light, and neither has the exact number of photons necessary for the formation of one molecule of glucose been known, so until now light has not been a usable parameter for the estimation of photosynthetic rates.

### SHORT DESCRIPTION OF THE METHOD OF THE INVENTION

Based upon the novel approach to the concept of photosynthesis it has now become possible to relate the light photon flux to the formation of one molecule of glucose by simple multiplication by the factor 1/36, because:
a) it takes 36 photons to form one molecule of glucose.
b) the factor light is related to the surface of the plant whereas the factor carbon dioxide is related to the weight (or volume) of the gross water flux related to photosynthesis;
c) a steady and simple relationship exists between the actual photosynthetic rate, the net photosynthetic rate and the light respiration rate and
d) the photosynthetic reaction is the fastest possible existing organic reaction.

By the method of the invention it is therefore possible to determine 1) the actual photosynthetic rate, 2) the net photosynthetic rate, 3) the light respiration rate, 4) the gross water flux rate and 5) the carbon dioxide and oxygen uptake and emission rates in connection with photosynthesis. Furthermore the actual velocity of the photosynthetic reaction has been computed by logic.

The method developed is characteristic by measurement of the light photon flux (photons, which can be used by plants for photosynthesis) combined with a measurement of the photosynthesising surface area of the plant connected to the measured light photon flux.

Determinations of the actual photosynthesis, the light respiration, the net photosynthesis and the hereto connected water, carbon dioxide and oxygen uptakes and emissions according to the new method are carried out as follows:

The actual photosynthesis (the gross photosynthesis): The light photon flux is measured with one or more light sensors, which count light photons that can be used by plants for photosynthesis. The light photon flux is converted to moles of glucose produced by the plant part, the plant, plants, or plant area per unit of time, by multiplying the photon flux measured by the factor 1/36, as it takes 36 photons to form one molecule of glucose. As it has been proved that the light flux is related to the surface area of the plant the plants, the actual photosynthetic rate of a plant is the light photon flux per plant surface area unit multiplied by the factor 1/36. The total actual photosynthesis of the plant is determined by multiplying the photosynthetic rate per surface area unit with the photosynthesising surface areas of the plant belonging to the measured photon fluxes. The actual photosynthesis reaches a maximum at the optimal photon flux for photosynthesis, 1/6 μmole cm⁻² s⁻¹, at which it grows constant at the value 1/6 μmmole cm⁻² s⁻¹. Measured light fluxes above the optimal light flux, 1/6 μmole μmole cm⁻² s⁻¹ (1667 μmole m² s⁻¹) should be calculated as being 1/6 μmole cm⁻² s⁻¹ for plants which do not possess an accessory carbon dioxide concentration mechanism. For plants which do possess an accessory carbon dioxide concentration mechanism, C₄ and CAM plants, the actual photosynthesis continues to follow the function 1/36× photon flux above the photon flux: 1/6 μmole μmole cm⁻² s⁻¹. Measurements should not be made at light photon fluxes above those to which the plant has been accommodated during growth. That light is the growth limiting factor and the actual photosynthesis follows the functions described above can be ascertained by making a plot of photosynthesis measured as carbon dioxide uptake as a function of light flux.

Light Respiration:

As the plant light respiration contributes with 5/6 of the carbon dioxide necessary for the actual photosynthesis, while the net photosynthesis with 1/6, it is now possible to determine the respiration of plants in light from the actual photosynthesis which is determined as described above, by multiplication with the conversion factor 5/6.

The light respiration rate can also be determined by a combination of the method relying on lightphoton flux and area and the traditional carbon dioxide uptake method:
the light respiration rate per area unit per time unit is: 1/36 (F*_{CO2}−photon flux)

As the respiratory rate is an expression of carbon dioxide emitted by respiration, the light respiration rate would most correctly be expressed as carbon dioxide emitted per unit of water per unit of time.

The light respiration rate per unit of water per unit of time is: 1/216 (1−F*_{CO2}/photon flux).

F_{CO2} is the carbon dioxide exchange per area unit, which can be measured by Infra Red Gas Analyser as described previously.
Air and water are connected to standard conditions for comparisons.
   Net Photosynthesis:

As the net photosynthesis is the expression for the external uptake of carbon dioxide necessary for the actual photosynthesis, which constitutes 1/6 of the actual photosynthesis, the net photosynthesis can be determiined as follows:

The net photosynthesis is: the measured light photon flux multiplied by the conversion factor 1/36 (=actual photosynthesis) times the factor 1/6, times the areas of the plant photosynthesising surface connected to the measured light photon flux. This result will be expressed in glucose equivalents. Multiplied by the factor 6, the result will be in carbon dioxide equivalents.

The Water Flux Rates:

The Gross Water Flux:

The gross water flux rate is the amount of water which according to the new photosynthetic equation is connected to the actual (gross) photosynthetic rate and passing through the one square centimetre, to which the actual photosynthesis per flux definition is connected. As it takes 12H₂O molecules and 36 light photons per glucose molecule formed,

the gross water flux rate through 1 cm² can be determined as the measured light photon flux per cm² multiplied with the conversion factor 1/36 (mole glucose formed) times 12.

The gross water flux in moles is therefore equal to the measured photon flux per square centimetre times the conversion factor 1/3. The result will be in moles per cm² per s. If the result is desired in grams per cm² per s: the gross water flux is 6 times the measured light photon flux, as the mole weight of water is 18 g.

Net Water Flux:

Half of the water molecules are, according to the photosynthetic equation, recirculated and the actual amount of water used for the actual photosynthesis will only be half of the gross water flux rate. If the water flux for a plant part, a plant or a plant area is desired, the measured photon fluxes should be multiplied with the plant surface areas, which are subjected to the light photon fluxes in question. The water fluxes connected to the net photosynthesis and the light respiration can be computed in the same manner in accordance with the photosynthetic and glycolytic (respiratory) equations.

The Carbon Dioxide Fluxes:

The carbon dioxide fluxes connected to the actual photosynthesis and the light respiration can now be calculated from a determination of the actual photosynthesis and light respiration by light photon flux and plant surface area as described above and the new photosynthetic equation where it takes 36 light photons to form a glucose molecule.

The Oxygen Fluxes:

The oxygen fluxes connected to the actual photosynthesis and the light respiration can now be determined from a determination of the actual photosynthesis and light respiration by light photonflux and plant surface area as described above and the new photosynthetic equation where it takes 36 light photons to form a glucose molecule.

When carbon dioxide is the growth limiting factor the rates will be determined by carbon dioxide. Carbon dioxide is related to water, to the gross water flux connected to the actual photosynthetic rate as the gross water flux is a function of the light photon flux as is the actual photosynthesis, the net photosynthesis and the light respiration. The connected carbon dioxide and oxygen exchanges in accordance with the new photosynthetic equation will therefore be constant when plant growth is limited by carbon dioxide.

The method of the invention can be universally employed for calculation of the actual photosynthesis (gross photosynthetic production) because it is very accurate and gives a quick and reliable estimate of photosynthesis wherever such an evaluation is necessary.

It is possible to compute the respiration of plants taking place in light either from the difference between the actual photosynthesis computed on the basis of the light photon flux and the net photosynthetic rate measured as carbon dioxide exchange or directly from a light photon flux measurement. It is absolutely novel that a determination of the actual photosynthetic rate, the respiration rate in light, and the gross water flux is possible. The method can replace the previously used carbon dioxide exchange, C¹⁴ and oxygen methods.

Moreover this new method gives the possibility of determinating the actual photosynthetic rate and the light respiration rate which has not been possible with the previous methods. The method can be worked effortlessly from great heights using aeroplanes and satellites, as the only measurements to be made are those of the light photon flux and the photosynthesising area. The method can be used in all sorts of apparatuses, computers and computer programs designed for estimation of plant productivity and photosynthesis. A precise measurement of the light photon flux over an area of soil over a period of time, for example a year, can give an exact image of how large a harvest is possible on the site in question. An accurate evaluation of whether improvement of plants, fertiliser or the like can bring an improvement of the harvest can be made by comparing the actual harvest with the potential harvest estimated in this manner.

The invention further relates to a device for use in the above method, enabling a direct determination of the actual photosynthesis (the gross photosynthesis) of plants by measuring the light photon flux falling on the photosynthetising surface area of the leaves and converting said flux to the specific amount of glucose produced per unit of the photosynthetising area of the plant or the plant area per unit of time. The device according to the invention comprises a photon fluxmeter combined with an area meter and connected to a computer unit which, based on the measured photon flux and area, can calculate and read out the total actual photosynthesis of the plant, the plant part or the plant area and, if desired, the light respiration, the water gross and net flux, oxygen and carbon dioxide change of the plant area in question.

Methods:

Measurement conditions: Be certain to measure under conditions as close to the natural conditions or the growth conditions as possible. Do not measure at light flux intensities larger than the ones to which the plants has been accommodated through growth, because their photosynthetic capacity may not be large enough to exploit the higher light flux intensity. Under most conditions light will be the growth limiting factor and the measurements can be computed in accordance with the present method, based on light photon flux and area. However if carbon dioxide, water or other pure growth conditions are the limiting factors, the actual photosynthetic rate, the net photosynthetic rate, the light respiration rate and other rates depending on these rates can be expected to be constant from a certain light flux level. This can be ascertained by producing a CO₂ exchange response curve to photon flux density.

The photon flux at which the CO₂ exchange gets constant is the photon flux which should be used for the calculation of the different rates. When either carbon dioxide or water is the growth limiting factor, the constant rates per unit of gross water flux should be used.

In general one can assume that light is the growth limiting factor up to the optimal light photon flux for plants of 1667 Imole m−2 s−1; above this photon flux carbon dioxide is the growth limiting factor except for plants with extra carbon dioxide uptake mechanisms such as C4 and CAM plants, for which light also is the growth limiting factor above the optimum light flux concentration.

A note on units: As flux is originally defined in centimetres, popularly expressed as the velocity of one cubic centimetre trough one square centimetre, comparisons of the different fluxes has to be made in centimetre units. This is important as the light flux is related to the surface area and carbon dioxide is related to the water weight and thereby to the gross water flux in connection with the actual photosynthesis of one square centimetre. The important relationship is that the unitless value of 1 square centimetre=the unitless value of 1 cubic centimetre=the unitless value of the weight of 1 cubic centimetre of water. All three values are equal to 1.

Determination of the Actual Photosynthetic Rate from Photon Flux Measurement:

(a) Determination of Rate Per Surface Unit of Plant:
1) The light photon flux is measured on the photosynthesising surface of the plant with a photon fluxmeter, which is designed to register photons to be utilized by plants for photosynthesis, for instance a photon fluxmeter from SKYE equipped with a PAR sensor.
2) The photon flux measurement is repeated the desired number of times and the average is calculated.
3) The actual photosynthetic rate is computed as:
   actual photosynthetic rate=1/36× photon flux
   (b) Measurement of a Whole Plant:
1) The photon flux is measured at different places on the plant (from brightest to darkest) with a photon fluxmeter.
2) The areas corresponding to the given photon fluxes are measured as well and noted. They can either be measured with an areameter, for instance an areameter of the type LI-COR. 3000, or the area can be determined by drawing the leaves on paper which can be weighed and compared with the weight of 1 cm² or 100 cm² of paper or drawn on millimetre or other squared paper where the squares can be counted.
3) The actual photosynthesis for the whole plant can thereafter be calculated by multiplying the actual photosynthetic rate by the areas belonging to the measured photon fluxes as outlined above. All results are added, and the total actual photosynthesis for the whole plant is thus calculated.
   (c) 24 Hour Measurement:

If an estimate is desired for a 24 hour period, the photon fluxes are measured on the photosynthesising surfaces in repeated intervals, for instance per hour. The areas are measured after finishing the measurements if they have to be harvested. The calculation is carried out as described above.

(d) Year Measurement:

If an estimate for a growth season or a year is desired, the photon flux and the corresponding areas are measured for e.g. ten plants, for example every other week. The average is calculated as described above.

All the different rates can then be calculated from the measured photon fluxes in accordance with the new photosynthetic equation:
6CO₂+12H₂O+36 photons------>C₆H₁₂O₆+6H₂O+6O₂
Large Scale Use of the Method According to the Invention:

For use in large scale working of the invention apparatuses, which measure the light photon flux falling on the plant surface and at the same time measure the surface areas of the plant corresponding to the light flux, would be convenient. All the measured results should be integrated by a computer to a total result for the whole plant, the plants or the plant areas after conversion of the measurements to actual photosynthesis, light respiration, net photosynthesis and the corresponding water, carbon dioxide and oxygen fluxes. The light flux for single plants should be measured at an angle perpendicular to the plant surface. The measurements can be made for small square units, for instance per square millimetre, but should preferably be calculated per square centimetre.

A device which simultaneously measures the light photon flux falling on different places of the leaf and the plant surface areas belonging to the measured photon fluxes may comprise a series of light sensors, which measure photoquanta that can be used for photosynthesis, and which is combined with an area measuring integrating stripe. The results are, e.g. by infra red rays, transferred to a computer where the results are calculated and worked out to for instance: actual photosynthesis, light respiration, net photosynthesis, gross and net water flux and the carbon dioxide and oxygen exchanges connected thereto.

For greater land areas the light photon flux falling perpendicular to the soil surface should be measured and multiplied by the corresponding plant covered area, the assumption being that all light photons coming from the sun, falling on a leave mosaic, are absorbed as if the soil had been covered by photosynthesising cloth. For example, small light photoquanta sensors, which are combined with a technique that is able to send the results to planes or satellites, are placed or thrown out on the place which is to be measured. From the satellite or plane the photosynthesising plant areas in question are estimated, e.g. by infra read photographing. For area estimation of phytoplanctonic algae, a special method must be developed, for instance counting (flow cytometry) in combination with area evaluation of the phytoplanctonic algae. An evaluation by photographic methods is also possible. For example, light sensors are placed on a stick for measurement of light photoquanta, which can be used for photosynthesis by phytoplancton. The plancton is photographed or collected at the corresponding depths for e.g. flowcytometry counting or in any other manner which will allow for surface area estimation of the phyto plancton. Leaf-like algae (thallophytes) can be estimated with a water tight device like for land plant or large area measurement methods.

The invention is further illustrated by means of the following examples, which are not intended to limit the invention in any way.

### EXAMPLES

### Example 1

### Determination of the Actual Photosynthesis Light Respiration and Water Flux on a Leaf

Determination on leaf of evergreen laurie from Mar. 5, 2001, 11 a.m., sunshine, air temperature: 2° C., Schleswig-Holstein, Germany.

The light photon flux was measured with a SKYE photon flux meter equipped with a PAR special sensor. The area of the leaf was in this insance drawn on millimeter squared paper and counted.

Measurements:

Photon flux on the leaf upside surface: 1490; 1486; 1484 μmole m⁻² s⁻¹;
Average=1487+/−3 μmole m⁻² s⁻¹.
Photon flux on leaf downside surface 91; 86; 75 μmole m⁻² s⁻¹;
Average=84+/−7 μmol e m⁻² s⁻¹.
The leaf surface area was determined to: 15.9 cm²,
The light photon flux: 1487 μmole m⁻² s⁻¹=0.1487 μmole cm²s⁻¹<1/6 (0.1667) μmole cm⁻² s⁻¹ and as the laurie has grown naturally and thus is assumed accomodated to the light photon flux at which the measurement takes place, light is assumed to be the growth limiting factor and the calculations are as follows:
   The Actual Photosynthesis of the Leaf:
Leaf upside, the actual photosynthesis=1/36× photon flux×leaf surface area:
0.1487/36 μmole cm⁻² s⁻¹×15.9 cm²=0.06567 μmole s⁻¹.
Leaf downside, the actual photosynthesis:
0.0084/36 μmole cm⁻² s⁻¹×5.9 cm²=00.00366 μmole s⁻¹.
Total leaf actual photosynthesis: 0.0693 μmole s⁻¹.

The Light Respiration of a Leafₐᵣₑₐ:
The total light respiration of the leaf=5/6× the actual photosynthesis:
15.9 cm²×(5/6×1/36×0.1487+5/6×1/36×0.0084) μmole cm⁻² s⁻¹=0.0579 μmole s⁻¹.
The net photosynthesis=The actual photosynthesis−light respiration=0.0693 μmole s⁻¹−0.0579 μmole s⁻¹=0.0114 μmole s⁻¹.
The gross water fluxₐᵣₑₐ calculated from photonflux
Gross water flux=6× photonflux×plant surface area:
total gross water flux: 15.9.cm²×6 (0.1487+0.0084) gcm⁻² s⁻¹=7.5 g s⁻¹.
The net water flux=3× photon flux×leaf area:
total net water flux: 15.9.cm²×3 (0.1487+0.0084) g cm⁻² s⁻¹=3.75 g s⁻¹.
The total water consumption of the leaf: gross=7.5 g s⁻¹; net=3.75 g s⁻¹.

### Example 2

### Comparison of the New Method with the Carbon Dioxide Exchange Method and Comparison of Light Respiration with a Combination of Light Flux and Carbon Dioxide Exchange Determination

Data originate from an experiment with Spartina anglica, a C₄ march grass grown in a 1% sodium chloride nutrient culture (Fanger, 1982, supra). The calculations are based on average values. The calculation of average values are omitted, as they are assumed known.

Measurements:

Light photon flux: 1900 μmole m⁻² s⁻=0.1900 μmole cm⁻² s⁻¹;
measured with a photon flux meter, LI-COR LI-188, Quantum, radiometer, photometer.
Leaf area: 5.1 cm² measured with a leaf areameter, LI-COR 3000.
Carbon dioxide exchange, _{FCO2 area}, =0.000959 μg s⁻¹ (rate: 0.0427 μmole cm⁻² s⁻¹).
Differential carbon dioxide measurements with an InfraRed Gas Analyser (IRGA)(Type Mk.3, The analytical Development Co. Limited).

As Spartina is a C₄ plant it is assumed limited by light also above the optimal photon flux of 0.1667 μmole cm⁻² s⁻¹.

1) Determination based on photon flux and area:
actual photosynthesis=1/36× photon flux×area=0.0269 μmole glucose s⁻¹
Light respiration per area unit, R_{Larea}=5/6× actual photosynthesis=0.0224 μmole glucose s⁻¹.
Net photosynthesisₐᵣₑₐ: actual photosynthesis−light respiration=0.0045 μmole glucose s⁻¹.
Gross water flux (g)=6× photon flux=1.14 g s⁻¹.
The correct way to express the light respiration and the net photosynthesis is in relation to the weight of the gross water flux, as they both are expressions of carbon dioxide production/uptake, which is related to the weght (volume) of water:
Light respiration_{w.weight}=Rₗₐᵣₑₐ/gross water flux=0.01965 μmole s⁻¹.
(light respiration rate per weight unit=0.0385 μmole g⁻¹s⁻)
Light respiration rate per water weight unit is, as noted above, constant: 5×6⁻⁴=0.0038 μmole g⁻¹ s⁻¹

Conclusion: The measured value and the theortical value for light respiration rate are in good correlation.

Determinations based on carbon dioxide exchange measurement:

Measured net photosynthetic rate; F_{CO2}area=1.88 mg CO₂ s⁻¹ divided by the mole weight of CO₂ (44 g) divided by the area (5.1 cm²) 0.0084 μmole CO₂ cm⁻² s⁻¹. Net photosynthetic rate determined by photon flux/area determination (see above)=0.0088 μmole CO₂ cm⁻² s⁻¹.

The determination of the net phototsynthesis by the new method and by the old method are practically identical.

Light Respiration:

The light respiration based on area (cm²): 1/36(photon flux −F*_{CO2})×area.
The light respiration based on gross water flux (g or cm³): 1/216 (1−F*_{CO2}/photon flux)×area.
(* F_{CO2} is the net photosynthetic rate measured as CO₂ exchange).

Light respiration related to area based on a method which combines light photon flux and carbon dioxide exchange in a method related to area:
1/36(0.1900−0.0427)×5.1=0.0263 μmole glucose s⁻¹.

The result solely based on the new light flux/area method:

Light respiration per area unit, R_{Larea=}5/6× actual photosynthesis=0.0224 μmole glucose s⁻¹

The results from the two methods are very alike.

Conclusion: The far easier photon flux method leads in this example to results, which are comparable to the carbon dioxide exchange method. Furthermore it is possible to combine the two methods with a very good result.

### Example 3

### Determination of the Maximal Possible Harvest Per Hectare Per Year

The maximal net photosynthetic=The maximal net photosynthetic rate is one sixth of the actual photosynthetic rate at the optimal photon flux: 1/6×1/36×1/6 μmole glucose cm⁻² s⁻¹. The weight of one mole of glucose is 180 g. One year is assumed to consist of 365 days with 12 hours of sunshine per day, with the optimum photon flux of 1/6 μmole cm⁻² s⁻¹=1667 μmole m⁻² s⁻¹.

The maximum net photosynthethis per hectare per year will under the above assumptions be: (1/6)⁴ μmole glucose cm⁻² s⁻¹×180 g/mole×10⁸ cm⁻² ha⁻¹×60×60 12×365 s year⁻¹=6000 kg m⁻² year⁻¹ or 60 tons of carbohydrate per hectare per year.

This result is of the same order of magnitude as the potential net photosynthesis per year in the tropics of 24-26 g m⁻² day⁻=88-95 tons per hectare per year according to Mc Gregor and Niewolt (Tropical climatology, John Whiley and Sons, 1998).

In Schleswig Holstein (Germany) the harwest of wheat (year 2000) is about 10 ton per hectare per year. The daily average of sunshine is 4.2 hours in Schleswig Holstein according to Ridder (Klimaregionen und typen in Nordwestdeutschland, Verlagsanstalt Heinr. & J. Lechte, Emsdetten in Westf. 1935). This average of 4.2 hours will, taken over a year, give a maximum possible net photosynthetic production of 21 tons per hectare per year. When those 21 tons per year are compared to the actual grain harvest of 10 tons of wheat grain per hectare per year, to which straw and underground biomass (roots) should be added, one is likely to be very close to the maximal harvest possible. A detailed study including straw and root biomass plus a precise registration of the light photon flux over a year will give a precise idea of whether an improvement of plant breeds, genetic engineering, fertilizer treatment or the like could improve the harvest.

1. A method for determination of the actual photosynthetic rate (the gross photosynthesis) of plants, wherein:
the light photon flux falling on the photosynthetising surface area of the leaves is measured and converted directly to the amount of glucose produced per unit of the photosynthetising area of the plant or the plant area per unit of time by means of the conversion factor 1/36, as it requires 36 photons to produce one molecule of glucose and light is related to the plant surface area,
the total actual photosynthesis of the plant, the plant part or the plant area is calculated by multiplying the actual photosynthetic rate by the size of the area, and optionally
the light respiration rate of plants is determined by multiplying the total actual photosynthesis by the conversion factor 5/6, as 5/6 of the amount of CO₂ necessary for the actual photosynthesis rate is produced by the light respiration.

2. A device for use in the method according to claim 1, enabling a direct determination of the actual photosynthetic rate (the gross photosynthesis) of plants by measuring the light photon flux falling on the photosynthetising surface area of the leaves and converting said flux to the specific amount of glucose produced per unit of the photosynthetising area of the plant or the plant area per unit of time, said device cornprising one or more photon fluxmeter(s) and an areameter connected to a computer unit which, based on the measured photon flux, can calculate and read out the total actual photosynthesis of the plant, the plant part or the plant area and, if desired, the light respiration rate of the plant area in question.

3. Use of the method according to claim 1 for the determination and evaluation of any process related to the actual photosynthesis, including plant growth, net photosynthesis, plant respiration in light, gross and net water flux, CO₂ uptake and oxygen emisslon.

4. Use of the method according to claim 1 for the evaluation of the growth of plants and algae, the actual photosynthesis and the light respiration based on a direct measurement of the light photon flux and the plant surface area and conversion of the measurement results to uptake and emission of CO₂, O₂ and H₂O in marine and fresh water environments.

5. Use of the method according to claim 1 for agricultural and forestal evaluation of any process related to the actual photosynthesis, including plant growth, net photosynthesis, plant respiration in light, gross and net water flux, CO₂ uptake and oxygen emission.

6. Use of the method according to claim 1 for the evaluation of the growth of plants and algae and for agricultural and forestal evaluation of any process related to the actual photosynthesis, including plant growth, net photosynthesis, plant respiration in light, gross and net water flux, CO₂ uptake and oxygen emission, where the measurements are carried out from a satellite or an aeroplane.

7. Use of the method according to claim 1 in an apparatus or in computers or computer programs of any kind for the evaluation of the growth of plants and algae and for agricultural and forestal evaluation in relation to the actual photosynthesis, including plant growth, net photosynthesis, plant respiration in light, gross and net water flux, CO₂ uptake and oxygen emission.

8. Use of the device according to claim 2, where the measurements are carried out from a satellite or an aeroplane.
